(19) United States
(12) Patent Application Publication
(10) Pub. No.: US 2026/0139778 A1
(43) Pub. Date: May 21, 2026

(54) Mechanical Connector for Conduit or Piping and Method of Using

(71) Applicant: Connection Technologies, LLC, Stuart, FL (US)

(72) Inventor: Libardo Ochoa, West Warwick, RI (US)

(73) Assignee: Connection Technologies, LLC, Stuart, FL (US)

(21) Appl. No.: 19/415,324

(22) Filed: Dec. 10, 2025

Related U.S. Application Data
(60) Provisional application No. 63/722,471, filed on Nov. 19, 2024.

(51) Int. Cl. F16L 37/088; F16L 37/091

(52) U.S. Cl. CPC F16L 37/0885; F16L 37/0915

(57) ABSTRACT

Many conduit, piping and tubing systems comprise interconnected components. The connector assemblies comprises a main body, optionally at least one sealing member, at least one gripper assembly, and a locking mechanism. The piping joint assembly or connection assembly may be used in fluid flow systems, pressurized systems, and conduit systems, for example. Embodiments of the joint assemblies, connection assembly, and methods facilitate a simple connection, simple disconnect, repair and reuse of the joint assembly or components of the joint assembly.

### TECHNICAL FIELD

Many conduit, piping and tubing systems comprise interconnected components. The components may be connected by various connector assemblies and methods. Embodiments of a conduit, tubing, or piping connector (joint assembly) comprises a main body, optionally at least one sealing member, at least one gripper assembly, and a locking assembly. The connector may be used in fluid flow systems, pressurized systems, and conduit systems, for example. Embodiments of the connector, joint assemblies, devices, and methods facilitate a simple connection, simple disconnect, repair and reuse of the joint assembly or components of the joint assembly.

### BACKGROUND

Piping systems and conduit exist to facilitate the flow of fluids (e.g., liquid, gases (such as air and fuel gases), or plasma, for example) and to protect electrical wires and components from exposure to the elements. For example, homes, schools, medical facilities, manufacturing facilities, commercial buildings, and other occupied structures generally require integrated piping systems so that water, fuels, coolants, and/or other fluids can be safely used. Electrical wires enter a building at a central location, typically into a distribution panel, and then wires distribute the electricity to various locations within the building, many times within conduit. Piping systems may be used to transport liquids and/or gases such as cold and hot water, breathable air, glycol, refrigerants, compressed air, inert gases, propane, natural gas, cleaning chemicals, wastewater, plant cooling water and paint and coatings are just some examples of the types of fluids and gases through or to facilities that use them. Conduits, tubing and piping types can include, for example, copper, stainless steel, galvanized steel, CPVC (chlorinated polyvinyl chloride) and PEX (cross-linked polyethylene). For purposes of the present disclosure, the term “pipe” or “piping” will be understood to encompass one or more pipes, conduits, tubes, piping elements and/or tubing elements.

In the past, pipe and conduit elements were traditionally connected by welding, threading, gluing, and/or soldering them together using a torch. Soldering and gluing fittings can be time-consuming, unsafe, and labor intensive. Soldering and gluing also may require employing any of the following tools materials emery cloth, sand paper, pipe-cleaning brushes, flux, silver solder, a soldering torch and striker, a tubing cutter, two part adhesives, and safety glasses, for example.

There is a need for a connection device that securely and easily connects conduit, tubing, or piping together.

### BRIEF DESCRIPTION OF THE DRAWINGS

FIG. 1 is an exploded perspective view of an embodiment of a piping joint assembly comprising a main body, sealing member, and a locking assembly, the locking assembly comprises a gripper with eight sets of teeth, on both edges of the concave ring;

FIG. 1a is an exploded perspective view of an embodiment of a piping joint assembly comprising a main body, sealing member, and a locking assembly, the locking assembly comprises a gripper with four sets of teeth, only on one side of the ring;

FIG. 2 is a perspective view of an embodiment of the main body of the joint assembly of FIG. 1 and FIG. 1a showing the inner volume that receives the sealing member and the locking assembly;

FIG. 3 is an end view of the main body of the piping joint assembly of FIG. 2 showing an axial through hole;

FIG. 4 is a front cross-sectional view of the main body along line 4-4 of FIG. 3 showing the interior contour of the main body;

FIGS. 4a, 4b, 4c, 4d, 4e, 4f, and 4g show an embodiment of the main body comprising two end caps;

FIGS. 5A and 5B are the front views, respectively, of a retaining member or gripper, FIG. 5A shows the open ring shape of an embodiment of a gripper, in some embodiments, the diameter L of the retaining member or the gripper in its unlocked configuration is larger than the outer diameter of the tubing, conduit or pipe to be connected, FIG. 5B shows the diameter L in the locked configuration of the retaining member or gripper, also the gap 11 in retaining member or gripper open ring shape of FIG. 5B in the locked configuration shown in FIG. 5B is shorter than the gap 11 in the unlocked configuration shown in FIG. 5A sine the diameter is reduced;

FIGS. 6 and 9 are left side and front views, respectively of the gripper of FIG. 1 in accordance with embodiments of the joint assembly wherein the gripper comprises a concave ring with gripper teeth with points on both edges of the concave ring;

FIG. 7-7 is a cross-sectional view of the gripper device taken along line 7-7 of FIG. 6;

FIG. 8-8 is an enlarged view of encircled portion 8-8 of FIG. 6 wherein the width of the set of gripper teeth is shown as K;

FIG. 10, FIG. 11, FIG. 12, and FIG. 13-13 depict an embodiment of a collar of the locking assembly, FIG. 10 depicts an end view of the collar with the pipe or tubing receiving aperture, FIG. 11 depicts a cross sectional view of the collar indicated by 11-11 in FIG. 10, FIG. 12 depicts a side view of the embodiment of the collar of FIG. 10 showing the collar windows defined in the collar, and FIG. 13-13 depicts an exploded view of the circled portion of the collar in FIG. 11 indicated with the 13-13;

FIGS. 14 to 15 depict a side view and an end view of an embodiment of a locking clip of the locking assembly, the locking clip pushed between the end of the main body and the collar to retain the collar in the locked position;

FIGS. 16 to 17 depict a side view and an end view of an embodiment of a sealing member that may be retained within the main body of the joint assembly, the sealing member surrounds the tube or conduit and compresses against the main body to provide a seal from the interior of the conduit to the outside environment;

FIGS. 17A and 17B depict a front view and side view, respectively of the gripper of FIG. 1s in accordance with embodiments of the joint assembly wherein the gripper comprises a concave ring with gripper teeth with points on only one edge of the ring;

FIGS. 18 and 18-18 depict the complete connection assembly in the unlocked position with a tube inserted into each end of the main body and the collar in the unlocked position; and

FIGS. 19 and 19-19 depict the complete connection assembly in the locked position with a tube inserted into each end after the locking clip has been pressed into the gap between the ridge on the collar and the end of the main body retaining the collar in the locked position.

### DESCRIPTION

Piping, tubing, conduit, and pressure systems include many components that need to connect together with connection assemblies to form the complete assembly. Embodiments of the connection assembly include a main body. The main body is configured to receive the conduit, piping, tubing, a fitting, or other component that will be connected together. The main body defines an aperture that is configured to receive the desired component. The properties of the aperture in the main body may vary based upon the application of the system. For example, the diameter, the depth, the internal configuration, the shape, the material of construction, and the thickness of the wall may be designed for the specific application. In most embodiments, the aperture will have circular cross-section to receive a pipe, tube, or tubular portion of another fitting. The exterior contour of the main body may be any contour that facilitates use and manipulation of the connector assembly and the interior contour is configured to slidingly receive and retain the collar and the locking assembly and retain the sealing member. The aperture may be an axial aperture and may also be a through hole.

Embodiments of the connection assembly comprise the main body and a locking assembly. The aperture of the main body receives the tubing, piping, component, or other fitting to be connected to another fitting or component or to cap the piping or tubing. The locking assembly retains the tubing, piping, component, or other fitting within the aperture. The locking assembly may comprise a gripper that grips, has teeth, or other protrusions that dig into, increases the friction with, or otherwise locks the tubing, piping, component, or other fitting into the main body thus retaining the tubing, piping, component, or other fitting within the aperture.

In some embodiments, the connection assembly may comprise a sealing member. The sealing member is configured to prevent leaking of gases or liquids from within or without the conduit, tubing, piping, component, or other fitting to the exterior of the connection assembly. The sealing member may be an o-ring, a square profile o-ring, a sealing sleeve, a gasket, silicone tape, washer, or other sealing members. The main body may define an internal feature such as an o-ring groove or gasket surface within the aperture to receive and retain the sealing member in the proper position. In some embodiments, the connection assembly may comprise two or more sealing members.

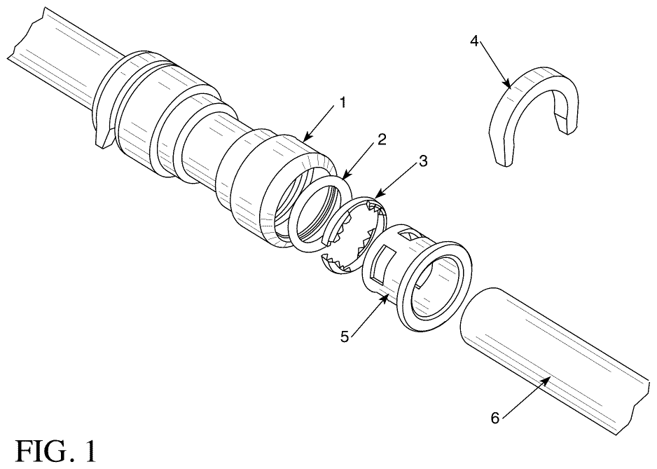

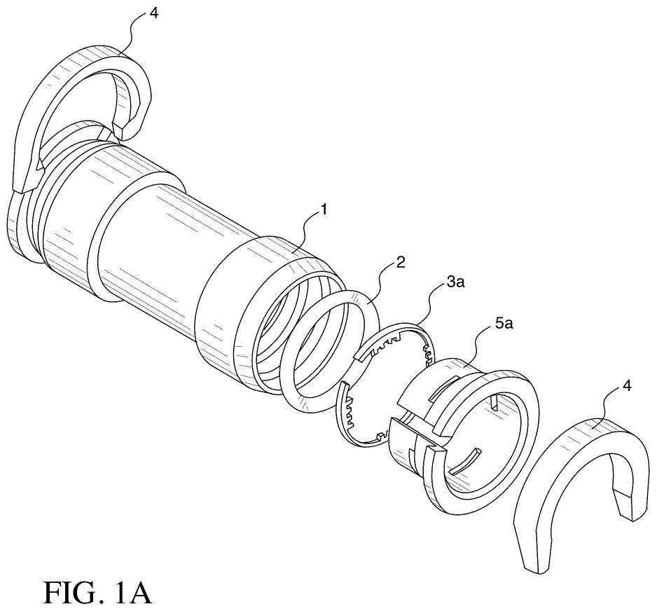

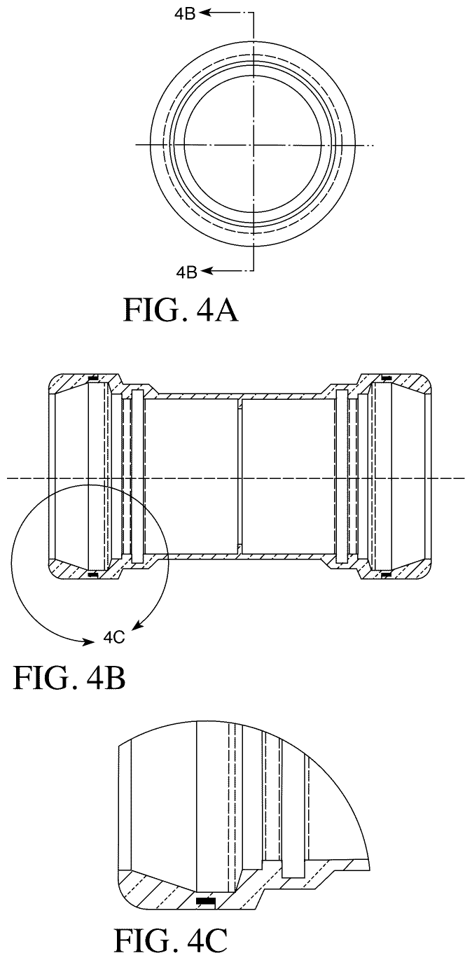

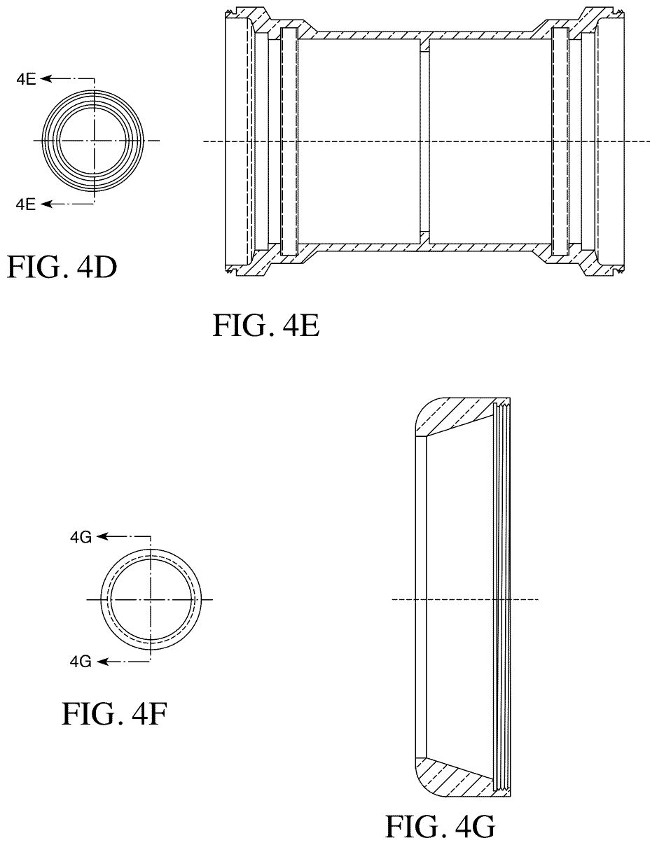

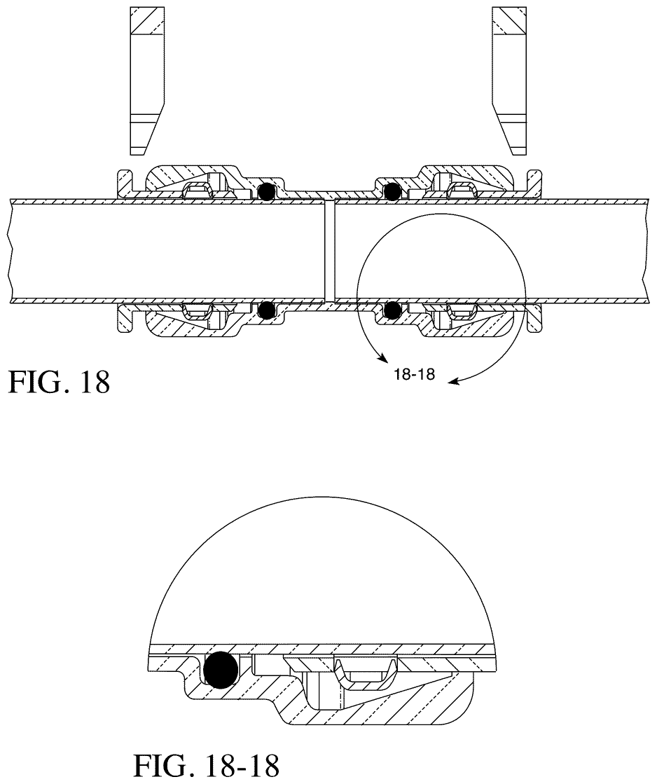

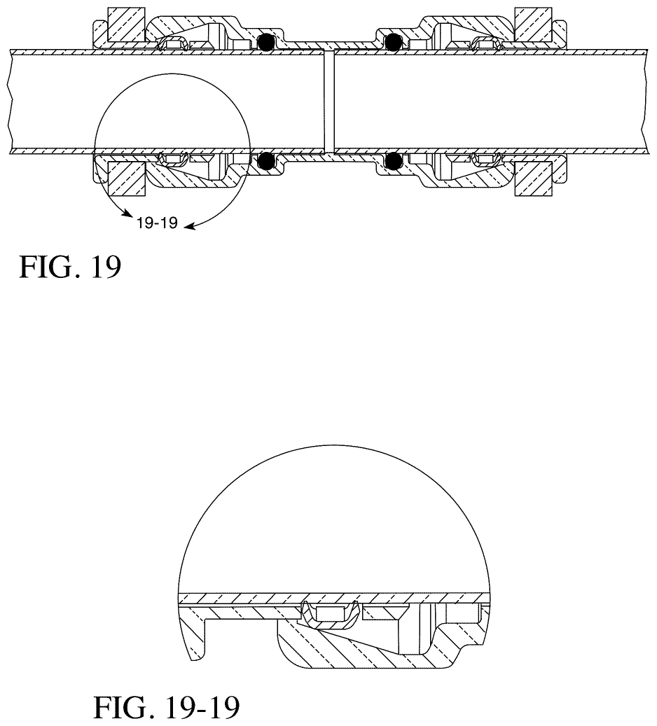

An embodiment of the connection assembly shown in FIG. 1 comprises a connector main body 1. In some embodiments, the connector main body 1 defines a main body axial aperture 8 (see FIG. 2) for receiving a conduit, tube, pipe, component, or other fitting. The component or fitting may be an elbow, valve, check valve, indicator, tee, or other component or fitting, for example. The connector assembly 1 may further comprise a collar 5 that is slidingly received at least partially within the aperture 8 of the main body 1. A portion of the connector main body 1 defines a collar gripper housing having a depth C (See FIG. 4). In some embodiments, the collar gripper housing may have a cone shaped section I with the larger diameter section toward the interior of the collar gripper housing and narrowing toward the opening that receives the conduit, tubing, piping, component, or other fitting. In another embodiment, the collar gripper housing may have a cone shaped section with the larger diameter section toward the opening that receives the conduit, tubing, piping, component, or other fitting and narrows toward interior of the collar gripper housing. The collar comprises an unlocked position and a locked position (See FIGS. 18, 18-18, 19, and 19-19) within the collar gripper housing. The locked position may be a position wherein the collar 3 is partially extracted from the connector main body 1. In another embodiment, the locked position may be a position wherein the collar 3 is inserted further into the connector main body 1 releasing the pressure of the gripper on the conduit, tubing, piping or other component. The collar 3 may extend out of the collar gripper housing and comprise a ridge 15 (See FIG. 12). This allows the collar 3 to be more easily moved from the unlocked position to the locked position. See FIG. 18 showing the collar in the unlocked position and see FIG. 19 showing the collar in the locked position.

The embodiment of the connector assembly in the figures further comprises a gripper 3. The gripper is slidingly received within the collar gripper housing and engages with the collar 5. In some embodiments, the collar 5 and the gripper 3 slide together from a locked position to an unlocked position. In the unlocked position, the gripper 3 is not sufficiently engaged with the conduit, tubing, piping, component, or other fitting to prevent movement of the tubing, piping, component, or other fitting relative to the connector main body 1. In the locked position, the gripper 3 is sufficiently engaged with the tubing, piping, component, or other fitting to prevent movement of the tubing, piping, component, or other fitting relative to the connector main body 1. The locking assembly may further comprise retaining means to retain the collar and the gripper in the locked position. The retaining means may be a locking clip 4, a retaining ring, a threaded connection wherein rotating of the collar relative to the main body moves the collar from the locked position to the unlocked position and back, an interference fit, a notch and groove, a hole and pin, threads, or other means that temporarily or permanently retains the collar and gripper in the locked position.

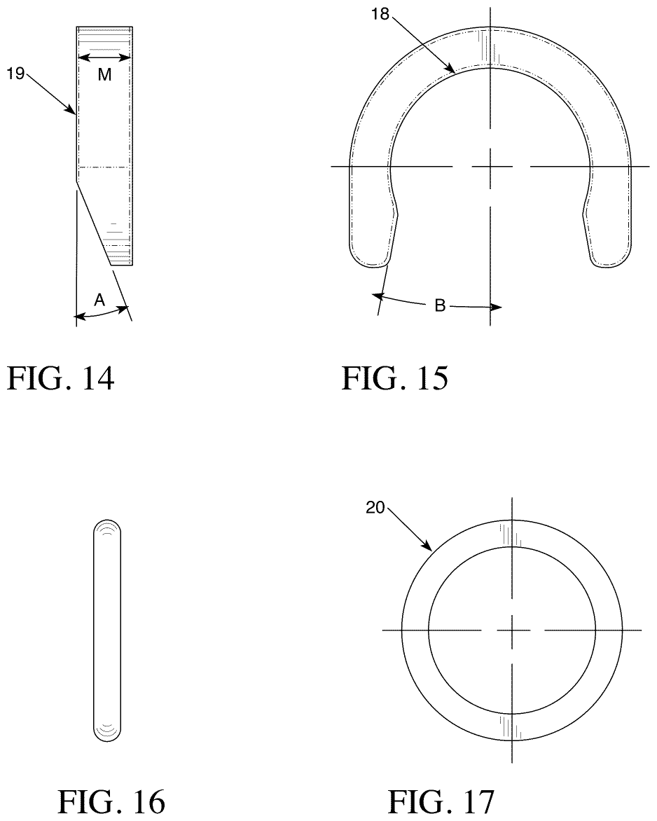

In one embodiment, the locking member is a locking clip 4 that is retained in a groove defined by a ridge on the collar and an end surface of the connector main body. The locking clip 4 may snap partially around a circumference of the collar 5 that is exposed when the collar is in the retracted locked position. The locking clip 4 may be removed to allow the collar to be moved from the locked position to the unlocked position to allow the conduit, tubing, piping, component, or other fitting to be removed from the connector main body. To ease installation, in some embodiments, the locking member may comprise an angled leading edge that is configured to drive the collar into the locked position. The angled leading edge may be defined by angle A (See FIG. 14). Alternatively, other locking means may be used. The locking may have a width M that is sufficient to retain the collar in the locked position. The outer surface of the locking member 19 drives the collar into the locked position and the inner diameter of the locking member corresponds to the outer diameter of the annular ring 14 of the collar.

The collar may define at least two gripper windows 16 in its circumference. In such embodiments, a portion of the grippers may extend from the exterior of the collar to the interior of the collar. The locking assembly functions by pressing a portion of the gripper against the conical portion of the main body though the gripper windows in the collar to engage the conduit, tubing, pipe, component, or other fitting thus locking the connector assembly onto the conduit, tubing, pipe, component, or other fitting. The collar may define at least two gripper windows. The number of gripper windows may be determined by the size or material of the conduit, tube, pipe, component, or other fitting, the amount of pressure in the system, or the necessity of electrical communication desired through the connector assembly, for example.

In the embodiment shown in the figures, the gripper has an open 11 circular shape with shape memory and is positioned between the collar and the main body with a gripping portion extending through the gripper window in the collar. This gripper may be compressed and will bias back to its original expanded shape. The gripper relaxes to its original larger diameter in the larger section of the conical collar gripper housing and is compressed to engage the pipe, tube, component, or other fitting in the smaller section of the collar gripper housing. The gripper is contacted by the walls of the collar window to move the gripper from locked position (compressed) to the unlocked position (relaxed). The collar slides within the collar gripper housing causing the gripper to engage the walls of the collar gripper housing from the larger diameter section to the smaller diameter section of the conical portion. This results in the gripper compressing and locking the conduit, tube, pipe, component, or other fitting within the main body to provide a secure connection. Therefore, the diameter of the gripper with the collar in the locked position is smaller than the diameter of the gripper with the collar in the unlocked position.

In some embodiments, the gripper comprises an electrically conductive material and provides electrical communication between the connector main body and the pipe, tube, component, or other fitting.

As shown in the figures, the gripper comprises a gripper portion that engages the conduit, tubing, pipe, or other fitting to lock it in the main body. For example, an embodiment of the gripper comprises a plurality of sets of gripper teeth 9 and the gripper teeth extend into the two gripper windows of the collar.

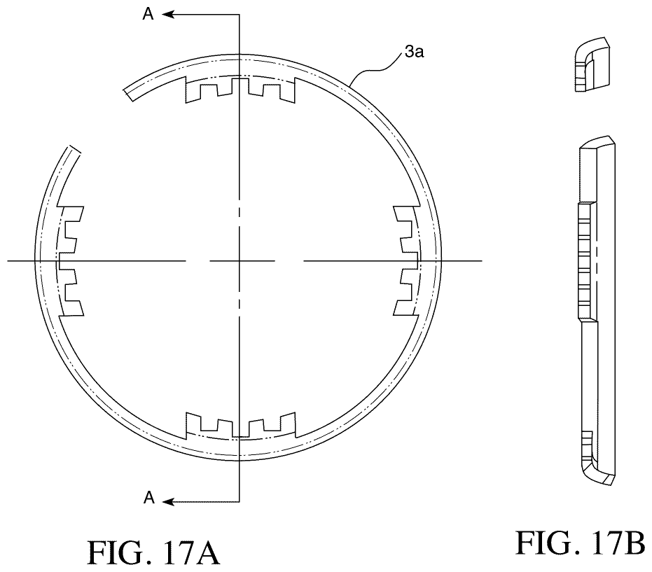

FIG. 1 is an exploded perspective view of an embodiment of a connection assembly comprising a main body 1, a sealing member 2, and a locking assembly (gripper 3, collar 5, and locking clip 4). The connection assembly is shown connecting two conduits together to form a secure connection. One end of the connection assembly is attached to one conduit and the other end is not yet connected. With the collar 5, the sealing member 2, and the gripper 3 properly installed in the main body 1, the conduit 6 is inserted into the main body through the collar aperture 13 until seated against the main body 1. The collar 5 is then moved from the unlocked position to the locked position and held in the locked position by connecting the locking clip 4 to the collar 5 between the wall of the main body 1 and the ridge 15 on the collar 5. The opposite procedure may be used to remove the pipe from the connector. FIG. 1a is an exploded perspective view of another embodiment of a connection assembly comprising a main body 1, a sealing member 2, and a locking assembly (gripper 3a with only one row of teeth, collar with that is not a complete cylinder 5a, and locking clip 4). The gripper with only one row of teeth is shown in FIGS. 17A and 17B, for example. The collar with that is not a complete cylinder 5a can be rolled or compressed to a smaller diameter or size. This smaller size may be more easily introduced through the opening of the main body. Once in the correct position within or partially within the main body, the manipulated collar 5a may be released. The flexible nature of the manipulated collar with that is not a complete cylinder 5a causes it to expand and open within the aperture. Since both the gripper 3a and the collar with that is not a complete cylinder 5a may be manipulated to a smaller diameter, the combined locking assembly (the gripper 3a and collar 5a) may be inserted into the aperture 8 main body 1 as an assembly. This allows a more efficient assembly process. The collar with that is not a complete cylinder 5a is shown having a lengthwise slot or cut that allows the collar 5a to be compressed.

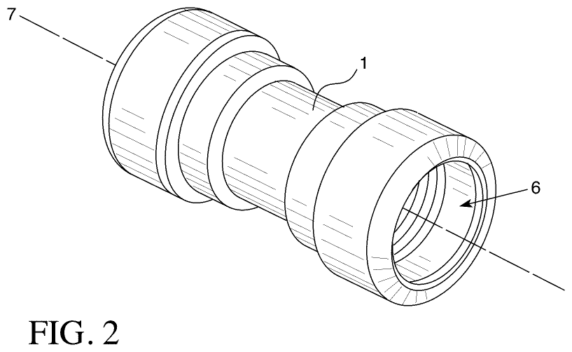

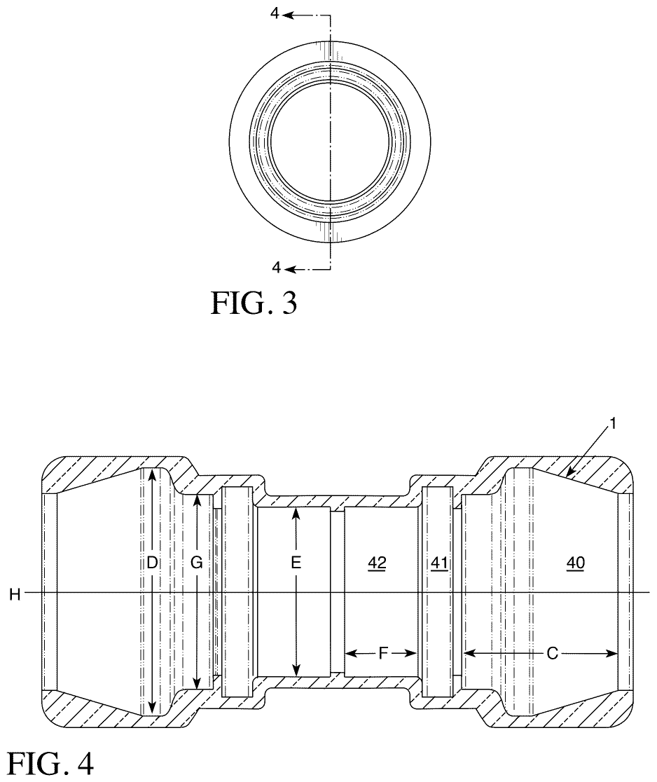

FIG. 2 is a perspective view of an embodiment of the main body of the connection assembly of FIG. 1 showing the aperture 8. In this embodiment, the aperture 8 of the main body 1 has an centerline 7. FIG. 2 shows the main body without the sealing member, the collar or gripper inserted. FIG. 3 is an end view of the main body of the main body of FIG. 2 showing the aperture as an axial through hole. FIG. 4 is a front cross-sectional view of the main body along line 4-4 of FIG. 3. The cross section shows the collar gripper portion 40 having a depth C, the sealing member groove 41, and the conduit or pipe portion 42 having a depth F and diameter E. The collar gripper portion 40 has a conical inner wall I and an inner diameter D and a smaller outer diameter H.

FIGS. 4a, 4b, 4c, 4d, 4e, 4f, and 4g show an embodiment of the main body comprising two end caps. FIG. 4a is an end view of the split body main body of the connector showing an axial through hole. FIG. 4b is a front cross-sectional view of the main body along line 4b-4b of FIG. 4a showing the interior contour of the central main body 52 and the two threaded end caps 51. The end caps 51 in this embodiment comprise a female threaded portion 53A that mates with the male threaded portion 53B. FIG. 4c shows the threaded connection in more detail. In other embodiments, the end cap may comprise the male threaded connection and the central main body may comprise the female threaded connection. The threaded connection allows the end cap to be removed and the internal components (locking assembly comprising the collar and the gripper and sealing member, for example) to be inserted into the central main body. Once the internal components are inserted, the end caps may be threaded on the central main body to retain the internal components in the central main body. FIG. 4d is an end view of the central main body of the connector without the end caps installed and FIG. 4e is a cross sectional view of the central main body of the connector without the end caps installed. FIG. 4f shows an end view of the end cap and FIG. 4g shows the cross sectional view of the end cap showing the inclined surface and the threaded connection.

The main body may be made by any structurally sufficient material such as metals, stainless steel, brass, copper, or plastic material such as a PVC. A main body may have a coating such as an epoxy powder coated main body.

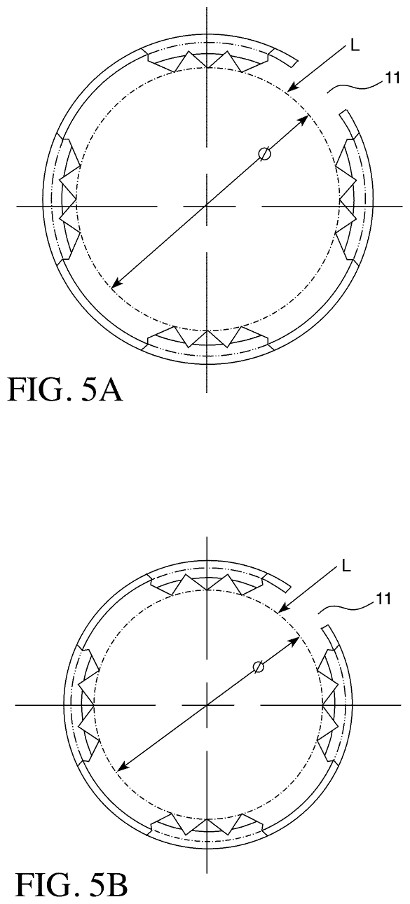

FIGS. 5A and 5B are the front views, respectively, of a retaining member or gripper 3, FIG. 5A shows the open ring shape of an embodiment of a gripper, in some embodiments, the diameter L of the retaining member or the gripper in its unlocked configuration is larger than the outer diameter of the tubing, conduit or pipe to be connected, FIG. 5B shows the diameter L in the locked configuration of the retaining member or gripper, also the gap 11 in retaining member or gripper open ring shape of FIG. 5B in the locked configuration shown in FIG. 5B is shorter than the gap 11 in the unlocked configuration shown in FIG. 5A in the compressed configuration with the diameter reduced. In the embodiment of FIGS. 5A and 5B, the gripper includes four sets of teeth with three teeth in each set of teeth. The diameter Ø of the gripper in the expanded unlocked position of FIG. 5A is greater than the diameter Ø of the biased locked position gripper of FIG. 5B. The diameter Ø may be any diameter that allows the desired pipe or tube size to be inserted through the gripper in the unlocked position but gripper portion (for example, the teeth) engage the pipe or tube in the locked position to lock the pipe or tube within the main body. The gripper may comprise a different gripper component (other than the teeth shown or differently shaped teeth such as the arc shaped teeth of gripper 3a), a different number of sets of teeth, and a different number of teeth in each set of teeth, for example. The gripper is merely configured to lock the tube or pipe in the main body. The gripper teeth may have sharp ends for securely engaging the tube or pipe. As shown, the sets of gripper teeth may be evenly spaced around the circumference of the ring 8. Such a configuration provides opposing forces on the pipe or tube to securely lock it to the main body.

In another embodiment of the gripper is shown in FIGS. 17A and 17B, the gripper includes four sets of teeth with four teeth each having an arc shape end. The gripper in the expanded unlocked position. This embodiment has differently shaped teeth and a different number of teeth than the embodiment shown in each set of teeth, for example. As the tube or conduit is pushed into the body, the teeth are pushed inwardly and angle the teeth toward the center of the main body. The gripper teeth position at this angle, restrain the tube or conduit by engaging the teeth. The gripper teeth may have curved or arc ends for more securely engaging the tube or conduit. As shown, the sets of gripper teeth may be evenly spaced around the circumference of the ring 8. Such a configuration provides opposing forces on the pipe or tube to securely lock it to the main body. The embodiment of FIGS. 17A and 17B only have one row of teeth and this gripper 3a may be considered to be one half of the gripper 3 shown in FIG. 7-7 and FIG. 9 in that regard.

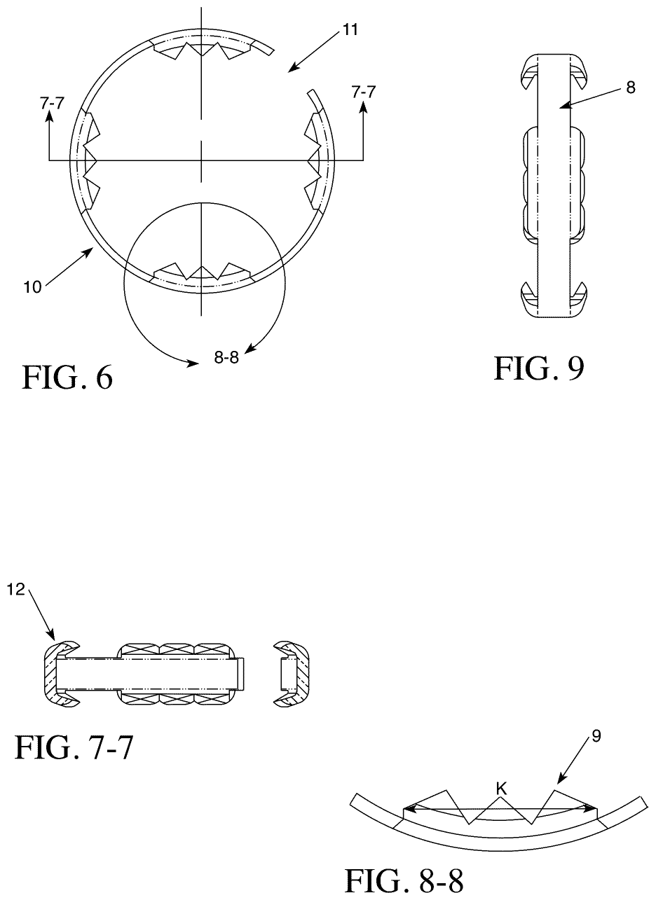

FIG. 6 is another view of the gripper 10 detailing the width of the gap 11 in the open circular shape of the gripper. FIG. 9 is left side view of the gripper in FIG. 6 showing the central ring 8 having a shape memory that supports the teeth on both side of the ring 8 separated by a width J. In this embodiment, the teeth extend outward from the concave ring 12 and upward toward the center of a circle defined by the ring 8., respectively of the gripper device in accordance with embodiments of the joint assembly.

FIG. 7-7 is a cross-sectional view of the gripper device taken along line 7-7 of FIG. 6 showing a set of teeth comprising two rows of three teeth each on opposite sides of the ring for a total of six teeth in each set. FIG. 8-8 is an enlarged view of encircled portion 8-8 of FIG. 6 wherein the width of the set of gripper teeth is shown as K.

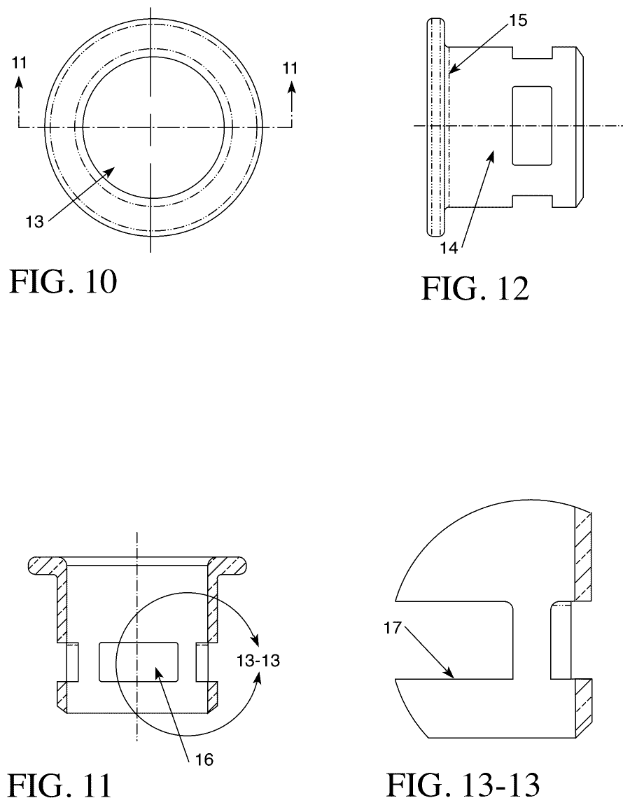

FIGS. 10 to 13-13 depict an embodiment of a collar of the locking assembly showing the aperture 13. The collar receives the pipe or tube and engages the gripper to move it from the unlocked position to the locked position. FIG. 10 depicts an end view of the collar with the pipe or tube receiving aperture 13. Embodiments of the connection assembly may comprise a collar with varying receiving apertures for accommodating various size pipes and tubes. FIG. 11 depicts a cross sectional view of the collar indicated by 11-11 in FIG. 10. The gripper windows 16 are defined in the circumferential walls 14 of the collar. FIG. 12 depicts a side view of the embodiment of the collar of FIG. 10 showing the collar windows 16 defined in the collar and the ridge 15 on the portion of the collar that is external to the main body. FIG. 13-13 depicts an exploded view of the circled portion of the collar in FIG. 11 indicated with the 13-13. The collar windows 16 comprise window surfaces 17 that push or pull the gripper into the locked and unlocked position.

FIGS. 14 to 15 depict a side view and an end view of an embodiment of locking clip of the locking assembly. In this embodiment, the locking clip is affixed to the collar and the end of the main body to ensure that the collar remains in the locked position. The width of the locking clip M is sized to move the collar a sufficient distance to engage the teeth into the pipe or tube.

The internal arc 18 of the locking clip is greater than 180 degrees such that the distance B is less than the outer radius of the collar.

FIGS. 16 to 17 depict a side view and an end view of an embodiment of a sealing member that may be retained within the main body of the joint assembly. Shown is an o-ring having an external diameter 20 that seals against the main body and an internal diameter that seals against the pipe, tube, component, or other fitting.

FIGS. 18 and 18-18 depict the complete connection assembly in the unlocked position with a tube inserted into each end. The gripper teeth in this embodiment are not sufficiently engage with the conduit or pipe to retain the conduit or pipe in the main body (See details of FIG. 18-18.

FIGS. 19 and 19-19 depict the complete connection assembly in the locked position with a tube inserted into each end after the locking clip has been pressed into the gap between the ridge on the collar and the end of the main body. This drives the collar and gripper into the narrower section of the collar gripper portion and thus drives the gripper teeth into the conduit or pipe.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A connector, comprising:
a connector main body, wherein the connector main body defines a main body axial aperture;
a collar slidingly received within the collar axial aperture, wherein the collar comprises a gripper window and an unlocked position and a locked position;
a gripper slidingly received with the axial aperture and at least partially extending through the gripper window

2. The connector of claim 1, comprising a locking member that retains the collar in the locked position.

3. The connector of claim 2, wherein the locking member is received between the connector main body and a ridge on the collar.

4. The connector of claim 3, wherein the locking member comprises an angled leading edge.

5. The connector of claim 1, comprising a sealing member.

6. The connector of claim 5, wherein the sealing member is an O-ring.

7. The connector of claim 6, wherein the O-ring is seated in a O-ring slot within an inner surface of the connector main body.

8. The connector of claim 1, wherein the main body axial aperture comprises a collar gripper housing.

9. The connector of claim 8, wherein the collar gripper housing has an internal conical shape.

10. The connector of claim 9, wherein the internal conical shape has a narrower diameter near the opening of the main body axial aperture.

11. The connector of claim 10, wherein collar extends out of the opening of the main body axial aperture.

12. The connector of claim 1, wherein the main body axial aperture is a through hole through the connector main body.

13. The connector of claim 12, wherein the through hole has circular cross sections of varying diameter.

14. The connector of claim 1, wherein the collar defines an axial aperture for receiving tubing.

15. The connector of claim 1, wherein the collar defines at least two gripper windows.

16. The connector of claim 1, wherein the gripper has an open circular shape.

17. The connector of claim 16, wherein a diameter of the gripper with the collar in the locked position is smaller than the diameter of the gripper with the collar in the unlocked position.

18. The connector of claim 1, wherein the gripper comprises an electrically conductive material and provides electrical communication with the connector main body.

19. The connector of claim 1, wherein the gripper is positioned between the collar and the connector main body.

20. The connector of claim 19, wherein the gripper comprises a plurality of gripper teeth and the gripper teeth extend into the two gripper windows of the collar.

21. The connector of claim 20, wherein the gripper teeth extend through the gripper windows with the collar in the locked position.

22. The connector of claim 1, wherein the collar has a lengthwise slot or cut that allows the collar to be compressed to facilitate assembly of the connector.
